(19) United States
(12) Patent Application Publication
(10) Pub. No.: US 2003/0081156 A1
(43) Pub. Date: May 1, 2003

(54) Back-lit display employing interference colour filters

(76) Inventors: Tijsbert Mathieu Henricus Creemers, Nijmegen (NL); Hugo Johan Cornelissen, Eindhoven (NL)

Correspondence Address: U.S. Philips Corporation, 580 White Plains Road, Tarrytown, NY, 10591, US

(21) Appl. No.: 10/281,806

(22) Filed: Oct. 28, 2002

(30) Foreign Application Priority Data
Oct. 31, 2001 (EP) 01204176.0

(51) Int. Cl. G02F 1/1335

(52) U.S. Cl. 349/106

(57) ABSTRACT

A back-lit colour display is disclosed, in which light from a backlight is filtered by a reflective filter structure arranged on a viewing side of the backlight. The reflective filter structure defines pixels having sub-pixels of red, green and blue colour. According to the invention, the filter structure comprises reflective regions having reflection bands that jointly cover the complete visible range of the spectrum, such that no gaps are present between the reflection bands. Preferably, the emission from the backlight is narrow band, and selected in such a way that the peak emission wavelength is within the corresponding reflection band, but close to the short wavelength cut-off thereof. Furthermore, the emission from the backlight is preferably selected to have a suitable overlap with the tri-stimulus functions of the human eye.

The present invention relates to back-lit displays employing interference colour filters. In particular, the present invention relates to transmissive displays having an improved colour reproduction.

Reflective colour filters are gaining more and more interest in the field of back-lit displays, primarily because reflective filters do not absorb light in the process of colour filtering. Hence, the efficiency of reflective filters can be much higher than that of absorbing colour filters.

Typically, reflective colour filters are based on interference effects, which by nature are colour (i.e. wavelength)-sensitive. However, interference filters have the general drawback that the reflected colour is dependent upon the viewing angle (angle of incidence). Therefore, the colour reproduction of displays employing interference colour filters is angle-dependent. In fact, the colour reproduction is more or less poor for essentially all oblique viewing angles. It is only at a normal angle of incidence (i.e. at a zero-degree angle of incidence) that the colour reproduction is optimal.

Optimally, a transmissive display based on reflective colour filters is viewed by a viewer from a normal direction, and lit by a backlight having a normal angle of incidence with respect to the filters. However, in any real situation, the viewer does not view the display from a normal direction, nor is the angle of incidence from the backlight normal to the filters. The viewing angle of the viewer in not a serious problem, since diffusers may be arranged in front of the filter structure of the transmissive display in order to spread the transmitted light towards the viewer. The backlight, however, will never be perfectly normal to the surface of the filter structure, because the backlight always exhibits at least some divergence. At least part of the backlight will always impinge on the filter at an oblique angle.

Although interference filters have some very attractive features, as compared with absorbing filters, there is still the problem of distorted colour reproduction at finite angles of incidence for the backlight. In order that interference colour filters gain commercial success, this problem must be solved.

When an interference filter is illuminated from an oblique angle rather than from a normal angle, a different wavelength is reflected, as compared with the situation at a normal angle of incidence, due to the filter having a different effective Bragg wavelength. As the angle of incidence with respect to the filter increases, the peak reflectivity of the filter shifts to shorter wavelengths. For colour displays, this is an annoying effect, even at moderate viewing angles. Furthermore, some light may have an angle of incidence that is so large that no reflection at all occurs at the filter. This means that a transmissive display that employs interference colour filters is likely to emit light of undesired wavelengths (i.e. colours) as soon as the angle of incidence of the backlight is too large.

Even at a normal angle of incidence, some light from the backlight may have a wavelength that falls outside the reflection bands of the filter structure. Of course, light of undesired wavelengths passing the filter structure impairs the colour reproduction.

One proposed way of preventing undesired wavelengths of light from passing the filter structure is to introduce absorbing layers in the filter structure, as suggested in WO 00/33129. However, absorption of light in order to prevent undesired light from leaving a display naturally lowers the efficiency of the display.

Consequently, there is a need for improved transmissive displays, for which the above-mentioned problems are less pronounced.

It is an object of the present invention to provide a colour display, based on interference colour filters, for which display the above-mentioned problem of distorted colour reproduction at oblique angles of incidence for the backlight is greatly reduced.

The above object is met by a display of the kind set forth in the appended claims.

The inventors have identified a problem concerned with the fact that interference colour filters are designed with separated reflectance bands at red, green and blue colours. When the backlight for such colour filters has a sufficiently large angle of incidence, some light will escape through the filter in the gaps between the reflectance bands. In effect, the colour reproduction is severely degraded. In order to eliminate this effect, the backlight has to be very collimated. Unfortunately, a high degree of collimation is typically obtained at the expense of brightness or efficiency.

The present invention proposes a way of dealing with the above-identified problem, without the need for a high degree of collimation of the backlight.

According to the invention, the filter structure is designed in such a way that the total filter function substantially covers the complete visible spectrum, and preferably extends also into the infrared region of the electromagnetic spectrum. In other words, the filter structure is designed without any spectral “gaps” between the reflection layers defining the sub-pixels (red, green and blue). Consequently, there are no such spectral “gaps” through which light may escape at an oblique angle of incidence, thereby greatly improving the colour reproduction of the filter structure. However, it is conceivable that there is no reflection for wavelengths between the shortest visible blue wavelength and the short wavelength onset of a blue emission band in the backlight. In other words, for wavelengths shorter than the shortest wavelength emitted by the backlight, there need not be any reflection in the filter structure.

According to the invention, it is further preferred that the backlight is selected to match the tri-stimulus functions of the human eye.

Furthermore, it is preferred that the colour filter spectrum is designed in such a way that the blue edge (the short wavelength edge) of each reflection band just covers the corresponding emission band. In this way, the largest possible shift due to oblique angles of incidence is allowed without serious colour distortion.

It is also recognised that the perceived effect of angular dependence of the reflectance/transmittance of interference filters is reduced when light having a wavelength band which is narrower than the reflectance/transmittance band of the filter is utilised. By employing a light source having a wavelength band that is narrower than the corresponding reflectance/transmittance band of the interference filter, the selection band of said filter can be allowed to have some shift without affecting light from other light sources. Basically, the narrower the wavelength band of the light source is as compared with the corresponding reflectance/transmittance band of the filter, the more said corresponding band of the filter may shift without any change in selected colour.

For colour filters, the transmitted spectral distribution is actually a convolution of the spectrum of the light source and the filter spectrum. When the colour filter has a narrower spectrum than the light source, the transmitted spectral distribution is primarily determined by the filter. On the other hand, when the light source has the narrower spectrum, the transmitted spectral distribution is primarily determined by the spectrum of the light source. Consequently, by employing narrowband light sources, the angle dependency of the filter may be reduced considerably. In the extreme case, where the light source emits a single wavelength (i.e. emitting light of one single wavelength), the transmitted spectral distribution is entirely independent of the filter characteristics, as long as the single wavelength is within the transmittance band of the filter. In the other extreme, when the light source is very broad band (almost flat over the wavelength range at issue), the transmitted spectral distribution is entirely determined by the filter characteristics.

Since the selected colour of the interference filter shifts towards shorter wavelengths (towards blue) for larger viewing angles, the colour filter should preferably be designed so that it selects just the desired colour on the blue side of its spectrum. In other words, the colour filter should be pre-shifted towards longer wavelengths (towards red) in order to allow a larger blue shift of the filter at oblique angles. In this way, larger shifts of the filter spectrum are allowed without any colour distortion occurring. Of course, it is at the same time important that the spectrum of the filter is confined so that it does not extend through more than one light source (one emission line).

Moreover, as mentioned above, it is preferred that the interference colour filter as a whole, i.e. the union of all reflection bands, covers all of the visible spectrum, without any spectral gaps, and even extends into the infrared region of the spectrum, i.e. every part of the visible spectrum should be reflected at least somewhere in the filter. Although narrowband light sources are preferably employed, oblique angles of incidence may cause light of undesired wavelengths to pass the filter through such gaps if they are present. In practice, the filter structure is preferably designed to actually have some spectral overlap between the filter functions of each reflection band, in order to completely eliminate transmitting gaps.

In the case where cholesteric colour filters are employed, gaps are preferably avoided by broadening the reflection band by providing the cholesteric structures with pitch gradients. Alternatively, two or more layers of cholesteric filters having slightly different centre reflection wavelengths can be arranged on top of each other.

A display according to the present invention comprises a number of pixels, each of which is made up of a blue, a green and a red sub-pixel. Within each pixel, the combined reflection spectra of the sub-pixels are designed in such a way that the full visible range of the electromagnetic spectrum is covered. Preferably, the reflection spectra also extends into infrared. Hence, within each pixel, there is reflection occurring for every visible wavelength of light. Towards the end of establishing each of the blue, the green and the red sub-pixel, transmitting regions are arranged in the appropriate areas of the pixel.

Generally, each of the red, green and blue sub-pixels has transmission bands that are defined by cyan-reflecting regions, magenta-reflecting regions and yellow-reflecting regions, respectively. In other words, a red sub-pixel is defined by a cyan-reflective region that reflects cyan, thereby transmitting red light. Similarly, a green sub-pixel is defined by a magenta-reflecting region, and a blue sub-pixel is defined by a yellow-reflecting region.

The cyan, magenta and yellow-reflecting regions can be formed by arranging red, green and blue-reflecting regions in series. For example, a cyan-reflecting region can be formed by arranging a blue-reflecting region and a green-reflecting region in series. Similarly, a magenta-reflecting region can be formed by a red and a blue-reflecting region in series, and a yellow-reflecting region can be formed by a red and a green-reflecting region in series.

However, it is to be understood that the above-mentioned reflecting regions can be formed in various other ways, such as by dielectric stacks or a layered structure of cholesteric filters, or other reflecting filters.

In one embodiment of the invention, the reflective filter structure comprises two layers of reflective interference filters, wherein each layer comprises an array of reflective areas for blue, green and red light. Said layers are shifted with respect to each other, such that the coloured sub/pixels (i.e. the blue, green and red areas) are defined by two reflecting layers reflecting different colours. For example, a blue sub-pixel is defined by two reflecting layers reflecting red and green light, respectively, thereby forming a yellow-reflecting region. Thus, there are three kinds of reflective areas, namely blue-reflecting areas, green-reflecting areas and red-reflecting areas. Stacking any two different such areas defines a coloured sub-pixel by forming a cyan, a magenta or a yellow-reflecting region. According to the present invention, the reflection spectra of said areas are juxtaposed, or slightly overlapping, such that the combined reflection spectrum covers the full visible range.

In another embodiment, each sub-pixel is defined by three shifted reflective layers, each layer comprising reflective areas for only one colour. In this case, each layer has open portions without any reflection at all. Every such portion defines a coloured sub-pixel. For example, an open portion in a red-reflecting layer defines a cyan-reflecting region and hence a red sub-pixel. It is to be understood that the other two layers must reflect green and blue light at this open portion in order to appropriately define the cyan-reflecting region.

Further aspects and features of the invention will be apparent from the following description of some preferred embodiments.

Preferred embodiments of the invention will be described hereinafter in more detail with reference to the accompanying drawings, in which:

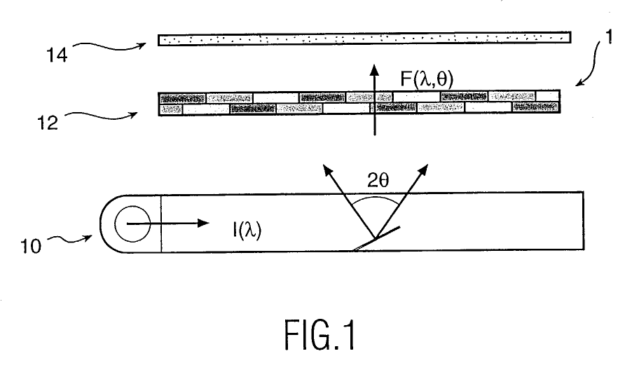

FIG. 1 schematically shows a section of a back-lit display employing reflective colour filters,

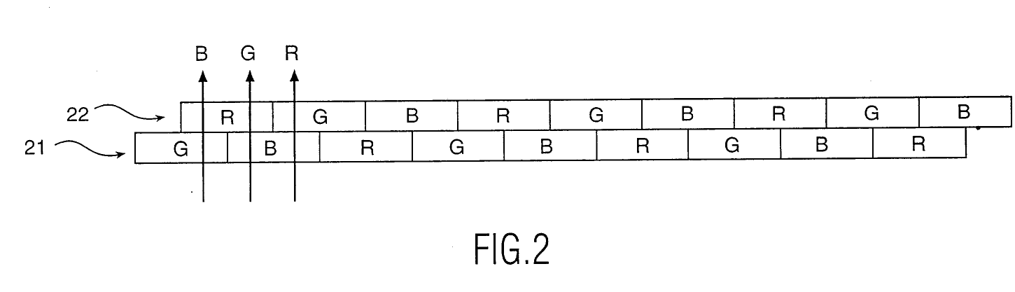

FIG. 2 schematically shows a first embodiment of a reflecting filter structure for a transmissive display,

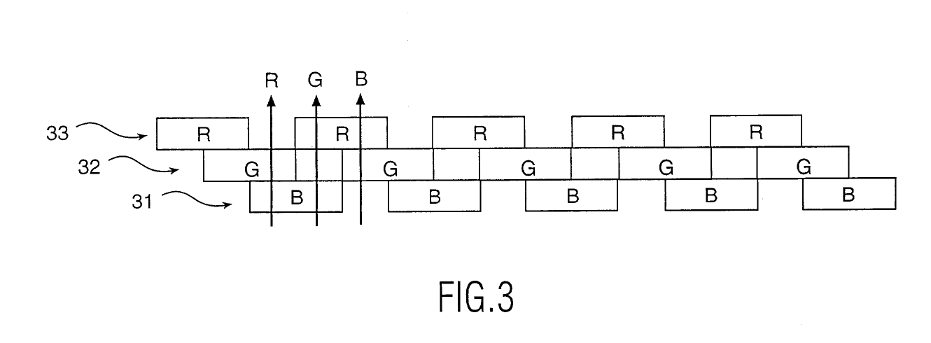

FIG. 3 schematically shows a second embodiment of a reflecting filter structure for a transmissive display,

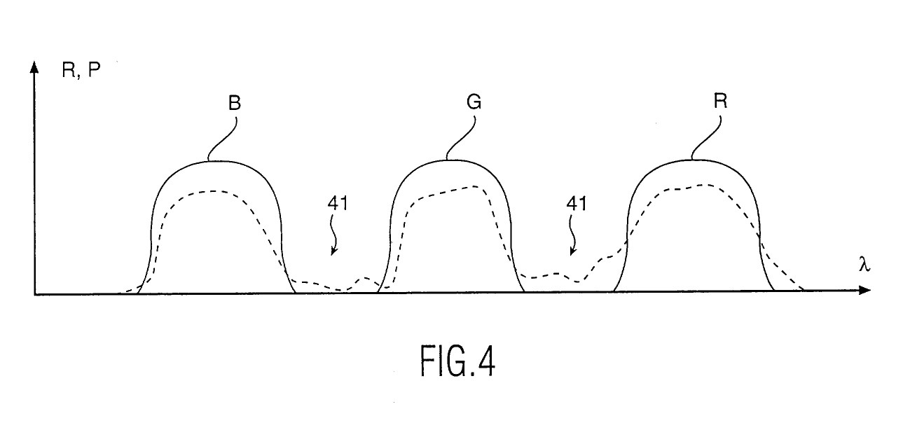

FIG. 4 schematically shows reflection bands and emission bands for a prior-art display,

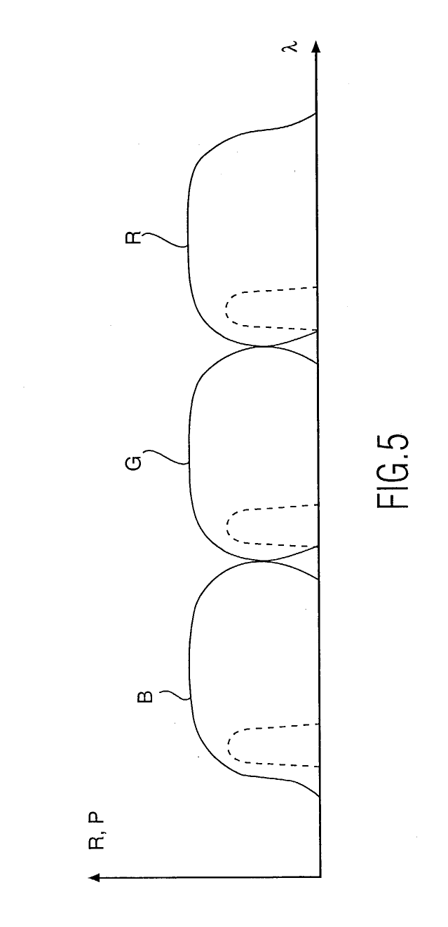

FIG. 5 schematically shows reflection bands and emission bands for a display according to the present invention,

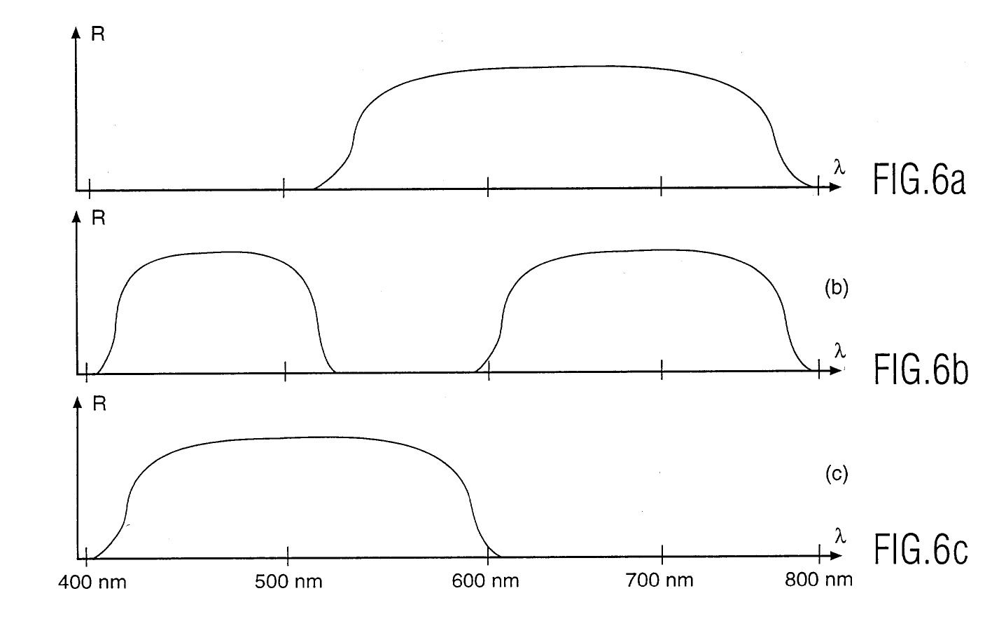

FIG. 6 schematically shows the inventive feature of (a) yellow, (b) magenta and (c) cyan-reflecting filter regions that jointly cover substantially the complete visible range of the spectrum,

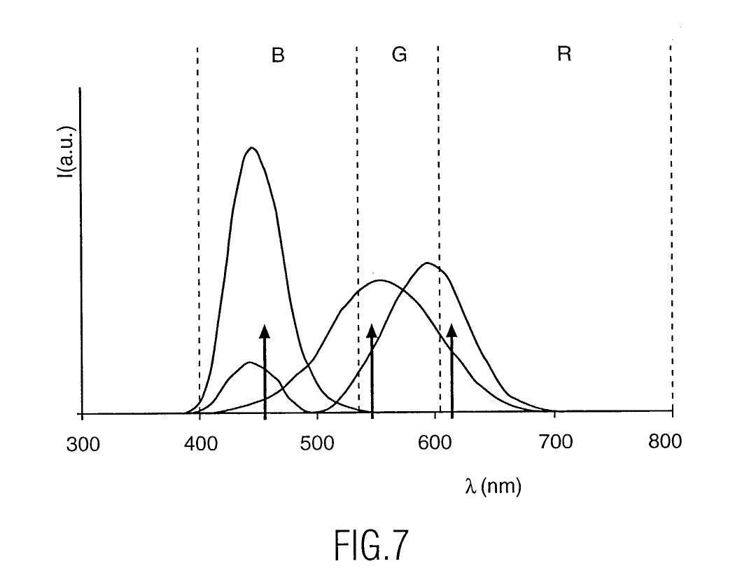

FIG. 7 schematically shows the tri-stimulus functions of the human eye, and preferred selections of the reflective filter structure and emission wavelength of the backlight,

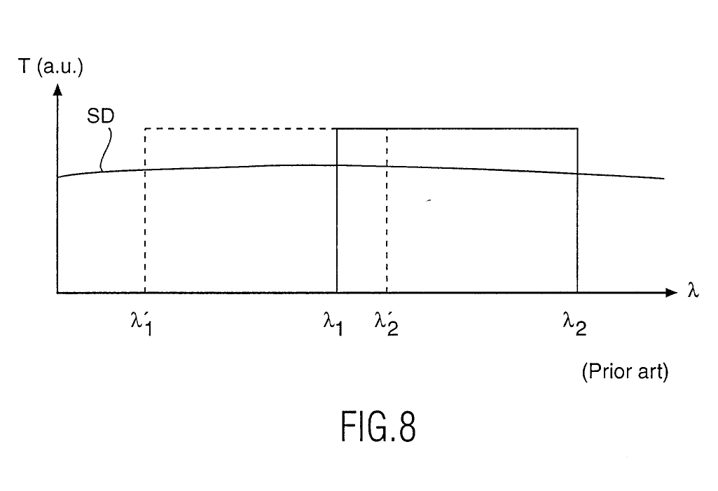

FIG. 8 schematically shows the angle dependency of the reflectance band for a prior-art display, and

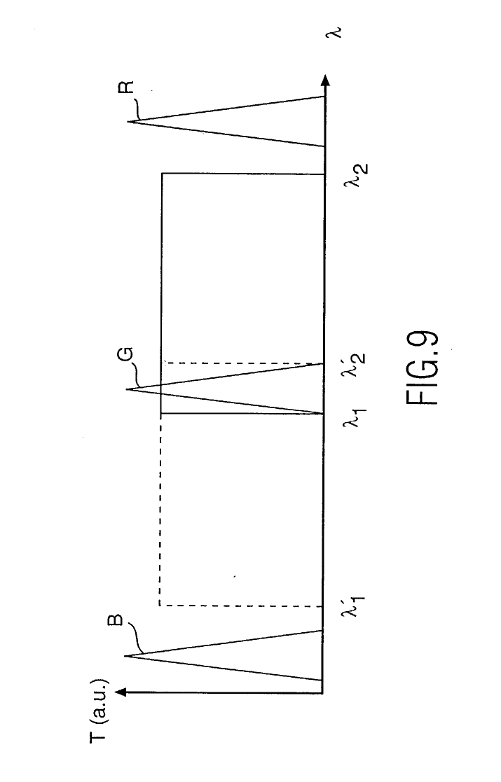

FIG. 9 schematically shows the angle dependency of the reflectance band for a display according to the present invention.

A back-lit colour display according to the present invention comprises many of the features of a transmissive display with reflecting filters according to the prior art. More specifically, and with reference to FIG. 1 of the accompanying drawings, the display 1 has a light source 10 for supplying the backlight; a circular polariser (not shown) for polarising the light from the light source 10; control means (not shown) for controlling the brightness of each individual pixel; a reflective filter structure 12 on a viewing side of the light source 10 for filtering out (i.e. transmit) the desired wavelength from the backlight; a diffuser 14 on the viewing side of the filter structure 12; and, optionally, a conventional reflector (not shown) on a rear side of the light source 10 for re-circulating light reflected by the filter structure 12. All this is common knowledge to the person skilled in the art.

The preferred filter structure is comprised of a layered structure of reflective regions. These reflective regions are ordered in such a way that they define three types of sub-pixels, namely red sub-pixels, green sub-pixels and blue sub-pixels, which together form a colour pixel of the display. Each sub-pixel of the preferred filter structure is defined by at least two reflecting regions, each of which is operative to reflect a respective one of the undesired two basic colours. More particularly, a red sub-pixel is defined by a green-reflecting region and a blue-reflecting region (together forming a cyan-reflecting region); a green sub-pixel is defined by a red-reflecting region and a blue-reflecting region (forming a magenta-reflecting region); and a blue sub-pixel is defined by a red-reflecting region and a green-reflecting region (forming a yellow-reflecting region). It is to be understood, however, that a single reflecting region alone may define a sub-pixel, provided that said single reflecting region constitutes a cyan, a magenta or a yellow-reflecting region.

A first embodiment of the reflective filter is schematically shown in FIG. 2. In this case, the filter structure is comprised of two layers 21, 22 of reflective material, wherein each layer includes regions for reflecting red (R), green (G) and blue (B) light. The two layers are laterally shifted with respect to each other, such that coloured sub-pixels are defined. Each coloured sub-pixel is defined by two reflecting layers reflecting different colour ranges. For example, and as schematically shown in FIG. 2, a blue sub-pixel is defined by a red-reflecting (R) and a green-reflecting (G) layer, said two layers together forming a yellow-reflecting layer. Similarly, a green sub-pixel is defined by a blue-reflecting (B) layer and a red-reflecting (R) layer, together forming a magenta-reflecting layer, and a red sub-pixel is defined by a blue-reflecting (B) layer and a green-reflecting (G) layer, together forming a cyan-reflecting layer. According to the present invention, the filters in each layer together, that is jointly, cover the complete visible range of the spectrum. This means that the long wavelength cut-off of the blue filter portion substantially coincides with the short wavelength cut-off of the green filter portion, and that the long wavelength cut-off of the green filter portion substantially coincides with the short wavelength cut-off of the red filter portion. In practice, the reflectance bands of the filter portions will, in fact, overlap slightly. Furthermore, the long wavelength cut-off of the red filter portion is preferably extended into the infrared region, in order to further enhance the performance of the filter structure at oblique angles of incidence for the backlight. The visible portion of the electromagnetic spectrum is generally defined to range from about 400 nm to about 700 nm. Light having a wavelength longer than about 700 nm is said to be infrared. Generally, it is to be understood that a blue-reflecting region and a green-reflecting region in series define a cyan-reflecting region, thereby forming a red sub-pixel. Similar situations apply for the green and the blue sub-pixels, as mentioned above.

In FIG. 3 shows another preferred filter structure. In the case shown in FIG. 3, the filter is comprised of three layers 31, 32, 33 of reflective regions. In contrast to the case shown in FIG. 2, each layer only contains reflective portions for one of the three basic colours. In this case, there are arranged open regions free from reflectivity in each layer in order to provide transmission for the appropriate colour of each sub-pixel. The open regions of each layer are offset, or shifted, with respect to the other layers. More particularly, an area where there is an open region in the layer comprising red-reflecting regions (R) is covered by green and blue-reflecting regions (G, B) in the two other layers. In this way, red sub-pixels are defined by an open region in the red-reflecting layer and a reflective region in each of the green and blue-reflecting regions, etc., such that red, green and blue sub-pixels are formed. The structure schematically shown in FIG. 3 may be preferred due to a less complicated manufacturing process, as compared with the structure shown in FIG. 2. As before, it is to be understood that a blue-reflecting region and a green-reflecting region in series define a cyan-reflecting region, thereby forming a red sub-pixel. Similar situations apply for the green and the blue sub-pixels, as mentioned above.

Referring now to FIGS. 4 and 5, the performance of a display according to the present invention will be described in more detail. For reference, prior-art filter characteristics are shown in FIG. 4. FIG. 5 shows the characteristics of a filter according to the present invention.

Normally, a transmissive cholesteric colour filter, for example, has a reflection band that is about 60 nrm wide. In a conventional display, in which there are three types of reflective regions (for red (R), green (G) and blue (B), respectively), this means that there are spectral gaps 41 between the reflection bands. This situation is schematically shown in FIG. 4. Light of a wavelength that falls within any such gap 41 will be transmitted by the filter at a normal angle of incidence for any type of sub-pixel. For larger angles of incidence, even light having a wavelength outside said gaps at normal incidence may be transmitted due to the blue-shift of the filter action.

According to the present invention, the reflection bands of the filter are broadened, such that no spectral gaps are present, as is schematically shown in FIG. 5. In practice, this means that the reflection bands, in fact, overlap slightly. Broadening of the reflection band of a cholesteric filter can be obtained by, for example, introducing pitch gradients in the chiral structure of the material. Alternatively, the effective reflection band may be broadened by layering a number of reflective regions, each having a slightly different pitch (and hence a slightly different centre reflection wavelength). Consequently, light may only pass the filter structure through the appropriately coloured sub-pixel.

Although the filter structure of the present invention provides a considerable improvement of the reproduced colours of the display, even when a broad-band backlight is utilised, it is preferred to use a backlight having a narrower emission spectrum. The emission spectrum of the backlight is indicated in FIGS. 4 and 5 by dashed lines. Furthermore, by designing the display in such a way that the peak emission wavelength of the backlight is just within the reflection band of the corresponding reflective region, in the sense that the short wavelength cut-off of the corresponding reflection band substantially coincides with the short wavelength flank of the emission band of the backlight, a further improvement of the reproduced colours is achieved. The reason for this improvement is that the closer the emission wavelength of the backlight is to the short-wavelength flank of the corresponding reflection band, the more said reflection band may shift towards shorter wavelengths (due to non-normal incidence of the backlight) before the colour starts to degrade.

The inventive feature of yellow, magenta and cyan-reflecting filter regions that jointly cover substantially the complete visible range of the spectrum is schematically shown in FIG. 6.

The reflection bands for (a) yellow, (b) magenta and (c) cyan are shown. As can be seen, a yellow-reflecting region (a) transmits light within the blue region of the spectrum, thus defining a blue sub-pixel; a magenta-reflecting region (b) transmits light within the green region of the spectrum, thus defining a transmission band for a green sub-pixel; and a cyan-reflecting region (c) transmits light within the red region of the spectrum, thus defining a transmission band for a red sub-pixel. In the Figure, it is indicated that any two different such regions in pairs cover substantially the complete visible range of the spectrum. In other words, the reflection bands of said regions are such that the complete visible range of the electromagnetic spectrum, from about 400 nm to about 700 nm, is substantially covered by any combination of two different such reflecting regions. Possibly, any light having a wavelength shorter than the shortest emitted wavelength from the backlight may remain uncovered, simply because no light is emitted in this region anyway. Furthermore, it is preferred to have the long wavelength cut-off of the yellow and magenta-reflecting regions extended into the infrared region of the spectrum, in order to allow a larger blue-shift of the filter action.

It has been found advantageous to select the emission wavelengths of the backlight to have a suitable overlap with the tri-stimulus functions of the human eye. The preferred selections of reflection bands and emission wavelengths for the backlight will now be described with reference to FIG. 7.

The tri-stimulus functions of the human eye are shown in FIG. 7 (solid curves). It is to be noted that the highest sensitivity of the eye is found at about 440 nm for blue, about 550 nm for green, and about 600 nm for red. The selected peak emission wavelengths for the preferred backlight are shown by vertical arrows in the Figure. Blue backlight is set to have a peak emission wavelength at 460 nm, green backlight at 540 nm, and red backlight at 612 nm. Generally, the respective peak emission wavelength of the backlight should preferably be within the ranges 450-470 nm, 530-550 nm and 600-620 nm. At the same time, the reflection bands of the filter structure are selected as follows. A blue reflection band (B) reaches from about 400 nm to about 530 nm, a green reflection band (G) from about 530 nm to about 605 nm, and a red reflection band (R) from about 605 nm to about 800 nm. The boundaries between these reflection bands are indicated by vertical broken lines in the Figure. Some important features of these selections should be pointed out. First, there are no “gaps” between the reflection bands; the reflection bands jointly cover the complete visible range of the electromagnetic spectrum. In fact, the reflection bands even overlap slightly at about 530 nm (the blue and the green reflection bands) and at about 605 nm (the green and the red reflection bands). Secondly, the long wavelength cut-off of the red reflection band is extended well into the infrared region of the spectrum in order to allow the largest possible blue-shift of the filter caused by the oblique angle of incidence for the backlight. Thirdly, each emission wavelength of the backlight is found relatively close to the short wavelength cut-off of the corresponding reflection band; again the reason being to allow the largest possible blue-shift for the filter at oblique angles of incidence for the backlight.

Narrow emission bands for the backlight are conveniently achieved by utilising light-emitting diodes. However, even if a backlight having broader emission bands is used, considerable improvements as compared with the prior art are achieved by selecting the reflection bands and the peak emission wavelengths in accordance with the teachings of the present invention.

The advantage of using narrow-band backlights, and selecting the reflection bands of the filter to have the corresponding emission band close to the short wavelength cutoff thereof, will now be described further with reference to FIGS. 8 and 9.

In the prior art, broadband light sources are employed together with reflective interference filters. In that case, the spectral distribution SD of the light source is almost flat in the spectral region of interest. This situation is schematically shown in FIG. 8. When the selected wavelength region of the filter is shifted towards blue at oblique angles of incidence, the centre wavelength of the transmitted light will also shift towards blue due to the light source being broad band. In effect, a large colour distortion will be perceived. At a normal viewing angle, the desired wavelength range is transmitted, for example light having a wavelength between λ₁ and λ₂ as shown with solid lines in the Figure. At an oblique viewing angle, the transmittance of the filter is shifted towards shorter wavelengths, and transmits light between λ₁ and λ₂ which is very different from the desired wavelength range. The situation at an oblique angle of incidence, where the transmittance band is shifted towards blue, is shown with broken lines in the Figure.

By employing narrow-band light sources, the above-mentioned problem is reduced dramatically. The general principle behind this effect will be described with reference to FIG. 9.

In FIG. 9, a light source emitting three sharp lines in each of the primary colours (red (R), green (G) and blue (B)) is employed. Equally, three individual light sources (e.g. LEDs) may be used, each emitting a respective one of said primary colours. The Figure schematically shows the transmittance band for the green colour at a normal angle of incidence (solid lines) and at an oblique angle of incidence (broken lines). It is to be noted that both the red and the blue emission from the light source are outside the green transmittance band at all times; neither red nor blue will therefore be transmitted by this filter.

At normal angles of incidence, the long wavelength cut-off of the green transmittance window should preferably be below the short wavelength tail of the red emission line, such that none, or at least very little, of this red line is transmitted through the green window. Also, the green emission line is preferably near the short wavelength cut-off in order to allow a large shift of the transmission window without losing transmission of the green line.

Similarly, when the transmission window is shifted towards blue due to an oblique angle of incidence for the backlight, the short wavelength cut-off of this transmission window should preferably be above the long wavelength tail of the blue emission line.

To conclude, the filter structure according to the present invention is based on the recognition that reflection should be provided for substantially all visible wavelengths for a back-lit display, regardless of the spectral characteristics of the backlight. The inventive filter structure comprises cyan, magenta and yellow-reflecting regions which have such reflection bands that the complete visible range of the spectrum is substantially covered by any combination of two such different regions. In this way, colour distortion due to a non-normal angle of incidence for the backlight onto the filter structure is greatly reduced. Further enhancement of the colour reproduction is obtained by combining the inventive filter with a narrow-band backlight.

It is to be understood that the detailed description above has an illustrative purpose, and that the scope of the invention is defined in the appended claims.

1. A back-lit colour display, comprising
a light source operative to emit light within the visible range of the electromagnetic spectrum, and
a filter structure arranged on a viewing side of said light source, said filter structure being operative to spectrally filter light emitted by said light source to provide colour pixels, each of which comprises a red, a green and a blue sub-pixel, wherein
the filter structure has cyan-reflecting regions defining a transmission band for the red sub-pixels, magenta-reflecting regions defining a transmission band for the green sub-pixels, and yellow-reflecting regions defining a transmission band for the blue sub-pixels, characterized in that
said cyan, magenta and yellow-reflecting regions have such reflection bands that the complete visible range of the electromagnetic spectrum is substantially covered by any combination of two such different reflecting regions.

2. A display as claimed in claim 1, wherein the spectral transmission bands for the sub-pixels are essentially non-overlapping and together cover substantially the complete visible range of the spectrum.

3. A display as claimed in claim 1 or 2, wherein
each cyan-reflecting region is defined by a blue-reflecting region and a green-reflecting region arranged in series in a viewing direction from the backlight,
each magenta-reflecting region is defined by a red-reflecting region and a blue-reflecting region arranged in series in said viewing direction, and
each yellow-reflecting region is defined by a red-reflecting region and a green-reflecting region arranged in series in said viewing direction.

4. A display as claimed in any one of the preceding claims, wherein the filter structure comprises interference colour filters selected from the group of filters comprised of cholesteric colour filters, holographic colour filters and interference stack colour filters.

5. A display as claimed in claim 3, wherein
the short wavelength cut-off of the red-reflecting regions and the long wavelength cut-off of the green-reflecting regions occur at approximately the same wavelength, and
the short wavelength cut-off of the green-reflecting regions and the long wavelength cut-off of the blue-reflecting regions occur at approximately the same wavelength.

6. A display as claimed in any one of the preceding claims, wherein the long wavelength cut-off of the magenta and yellow-reflecting regions occurs in the infrared range of the electromagnetic spectrum.

7. A display as claimed in any one of the preceding claims, wherein the light source is operative to emit light within at least three confined emission bands, the peak wavelength of each falling within a respective one of the transmission bands of the red sub-pixels, the green sub-pixels and the blue sub-pixels,
each of said emission bands further being narrower than the corresponding transmission band.

8. A display as claimed in claim 7, wherein the emission bands have peak emission wavelengths between 450 and 470 nm for blue, between 530 and 550 nm for green, and between 600 and 620 nm for red, such that the emission bands overlap with the tri-stimulus functions of the human eye.

9. A display as claimed in claim 7 or 8, wherein the peak wavelength of each emission band falls on the short wavelength cut-off of the corresponding transmission band.

10. A display as claimed in any one of the preceding claims, wherein the light source comprises red, green and blue light-emitting diodes.

11. A display as claimed in any one of the preceding claims, wherein the filter structure comprises a cholesteric material in which the reflection band has been broadened by providing the material with pitch gradients.

12. A display as claimed in any one of claims 1 to 10, wherein the filter structure comprises two or more reflecting layers, which have slightly different centre reflection wavelengths to jointly form a reflecting region having a broadened reflection band.

13. A filter structure for a back-lit colour display, said filter structure having cyan-reflecting regions defining a transmission band for red sub-pixels; magenta-reflecting regions defining a transmission band for green sub-pixels; and yellow-reflecting regions defining a transmission band for blue sub-pixels, characterized in that said cyan, magenta and yellow-reflecting regions have reflection bands such that any combination of two such different reflecting regions provides reflection for light of any wavelength within a wavelength range from about 450 nm to about 700 nm, without exhibiting any spectral reflection gaps within said wavelength range.

14. A filter structure as claimed in claim 13, wherein each cyan-reflecting region is defined by a blue-reflecting region and a green-reflecting region arranged in series in a viewing direction; each magenta-reflecting region is defined by a red-reflecting region and a blue-reflecting region arranged in series in said viewing direction; and each yellow-reflecting region is defined by a red-reflecting region and a green-reflecting region arranged in series in said viewing direction.

15. A filter structure as claimed in claim 13 or 14, comprising filters selected from the group of filters comprised of cholesteric colour filters, holographic colour filters and interference stack colour filters.

16. A filter structure as claimed in any one of claims 13 to 15, wherein the long wavelength cut-off of the magenta and yellow-reflecting regions occurs in the infrared regions of the electromagnetic spectrum.

17. A filter structure as claimed in any one of claims 13 to 16, comprising reflecting regions of a cholesteric material for which the reflection band has been broadened by providing the material with pitch gradients.

18. A filter structure as claimed in any one of claims 13 to 16, comprising two or more reflecting layers, which have slightly different centre reflection wavelengths to jointly form a reflecting region having a broadened reflection band.
